(19) United States
(12) Patent Application Publication
(10) Pub. No.: US 2015/0302761 A1
(43) Pub. Date: Oct. 22, 2015

(54) MANAGING HEALTH AND FITNESS USING SOCIAL NETWORKING APPLICATIONS

(71) Applicant: Rewired Health, LLC, Healdsburg, CA (US)

(72) Inventor: Darcie Lamond, Healdsburg, CA (US)

(21) Appl. No.: 14/591,604

(22) Filed: Jan. 7, 2015

Related U.S. Application Data
(60) Provisional application No. 61/924,911, filed on Jan. 8, 2014.

(51) Int. Cl. G09B 19/00; G09B 5/02

(52) U.S. Cl. CPC G09B 19/00; G09B 5/02

(57) ABSTRACT

Technology is disclosed for managing health and fitness using a social networking application (“the technology”). The technology provides a social networking application (“app”) that allows a player to select and/or formulate a particular “Track” which indicates a positive trait, and to invite other users to acknowledge/encourage the progress of the player on the chosen Track. The player accumulates rewards, e.g., points, when another user acknowledges the progress of the player. When the rewards reach a threshold, the player is said to have achieved the goal of the Track, thereby improving his fitness. The player can share the Track and the activities performed towards implementing the Track with other users via a “TrackChat” with other users. The other user can decide whether the activities are inline with achieving the goal of the track and if so, acknowledge them, thereby helping the player to earn rewards.

### CROSS-REFERENCE TO RELATED APPLICATION(S)

This application claims the benefit of U.S. Provisional Patent Application No. 61/924,911, entitled “MANAGING HEALTH AND FITNESS USING SOCIAL NETWORKING APPLICATIONS”, filed on Jan. 8, 2014, which is incorporated by reference herein in its entirety.

### TECHNICAL FIELD

Several of the disclosed embodiments relate to health and fitness, and more particularly, to social networking applications that facilitate managing health and fitness.

### BACKGROUND

Current health and fitness applications track and report on behavior but fail to offer emotional support for people to get and stay healthy. They also fail to address the psychological barriers that stand in the way of consistently choosing healthy behaviors. They also limit social engagements to one way input on accomplishments instead of two way interactions, including ones with fitness professionals, for obtaining motivation, and encouragement, to change the thinking that drives behavior. Most fitness and weight loss apps are “tracking apps”, they gather data on people's behavior then present it back to them and to others. None of these apps take aim at the underlying thinking that drives behavior. The fitness and weight management world doesn't apply social media to encouraging a person to adopt a new way of thinking, instead it is used as an audience that comments on posted results, accomplishments and challenges. Current landscape of fitness and weight management apps lack engagement of social support groups in exercises of declaration of intention and acknowledgement by others as a way to recondition thinking.

### SUMMARY

Technology is disclosed for managing health and fitness (hereinafter referred to as simply “fitness”) using a social networking application (“the technology”). Various embodiments of the technology provide a social networking application that allows a user (also referred to as a “player”) to select and/or formulate a particular “Track” which indicates a particular positive trait and invite other users to acknowledge or encourage the progress of the user on the chosen Track. The player accumulates rewards, e.g., points, when another user acknowledges the progress of the user in implementing the particular Track. When the rewards reach a particular threshold, the player is said to have adopted the new thinking described in the particular Track, thereby improving his fitness.

The player can share the track and the activities performed towards achieving the goal of the Track with other users in various ways, including a “TrackChat” (hereinafter also referred to as “chat”). In a TrackChat, the player can initiate a messaging exchange with other users, e.g., a friend of the player, and chat regarding the activities performed towards achieving the goal of the Track. The friend of the player can decide whether the activities performed by the player are in fact towards achieving the goal of the Track and if so, acknowledge the activities of the user. The player can invite other users to the Track chat or be part of a group created by a service provider, such as a fitness professional, and chat with the service provider to obtain the acknowledgement.

The technology also provides an effective way for service providers, e.g., fitness professionals, to provide consultation, guide and encourage their clients to improve fitness, and monitor and acknowledge their clients' progress in implementing their respective Tracks.

### BRIEF DESCRIPTION OF THE DRAWINGS

FIG. 1 is a block diagram of an environment 100 in which embodiments of the disclosed technology can be implemented.

FIGS. 2A and 2B illustrate example user interfaces for selecting an avatar to represent a player, consistent with various embodiments of the disclosed technology.

FIGS. 3A and 3B illustrate example user interfaces for creating or selecting a track, consistent with various embodiments of the disclosed technology.

FIG. 4 illustrates a user interface depicting negative clouds for a chosen Track, consistent with various embodiments of the disclosed technology.

FIGS. 5A and 5B illustrate user interfaces for inviting players to participate in a TrackChat, consistent with various embodiments of the disclosed technology.

FIGS. 6A and 6B illustrate user interfaces for chatting with players in a TrackChat, consistent with various embodiments of the disclosed technology.

FIGS. 7A and 7B illustrate another set of user interfaces for chatting with players in a TrackChat, consistent with various embodiments of the disclosed technology.

FIG. 8 is an example of a user interface illustrating a profile of a player, consistent with various embodiments of the disclosed technology.

FIG. 9A is an example of a user interface used by a service provider for creating a group of players, consistent with various embodiments of the disclosed technology.

FIG. 9B is an example of a user interface for setting the attributes of the group, consistent with various embodiments of the disclosed technology.

FIG. 10A is an example of a user interface for setting group leader availability times for a particular group, consistent with various embodiments of the disclosed technology.

FIG. 10B is an example of a user interface for sending messages to the players in the group.

FIG. 11 is a block diagram of a computer system as may be used to implement features of some embodiments of the disclosed technology.

### DETAILED DESCRIPTION

Technology is disclosed for managing health and fitness (hereinafter referred to as simply “fitness”) using a social networking application (“the technology”). Various embodiments of the technology provide a social networking application that allows a user (also referred to as a “player”) to select and/or formulate a particular “Track” which indicates a particular positive trait and invite other users to acknowledge or encourage the progress of the user on the chosen Track. The player accumulates rewards, e.g., points, when another user acknowledges the progress of the user in implementing the particular Track. When the rewards reach a particular threshold, the player is said to have adopted the new thinking described in the particular Track, thereby improving his fitness.

The player can share the track and the activities performed towards achieving the goal of the Track with other users in various ways, including a “TrackChat” (hereinafter also referred to as “chat”). In a TrackChat, the player can initiate a messaging exchange with other users, e.g., a friend of the player, and chat regarding the activities performed towards achieving the goal of the Track. The friend of the player can decide whether the activities performed by the player are in fact towards achieving the goal of the Track and if so, acknowledge the activities of the user. The player can invite other users to the Track chat or be part of a group created by a service provider, such as a fitness professional, and chat with the service provider to obtain the acknowledgement.

The technology also provides an effective way for service providers, e.g., fitness professionals, to provide consultation, guide and encourage their clients to improve fitness, and monitor and acknowledge their clients' progress in implementing their respective Tracks.

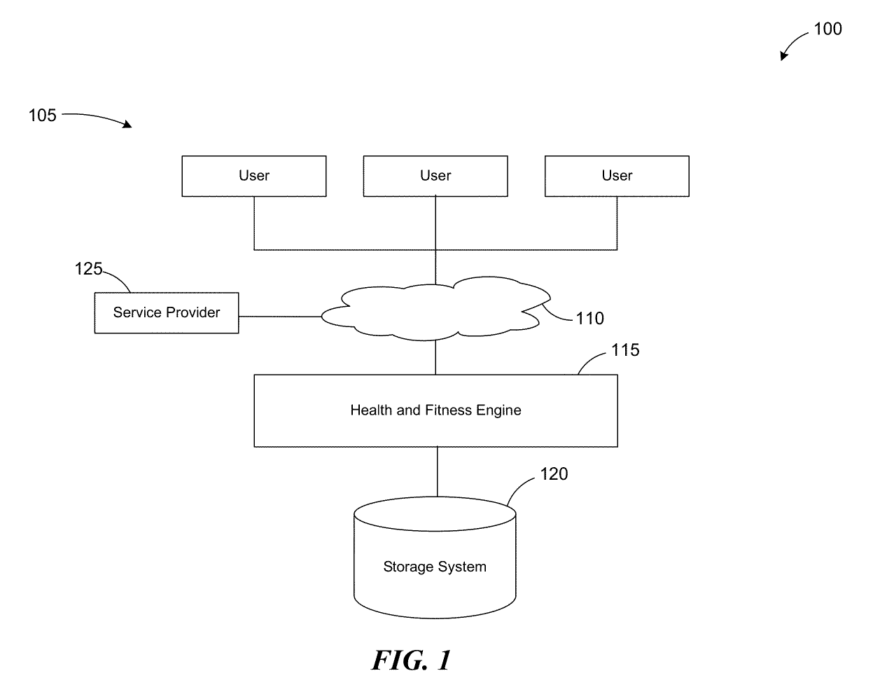

FIG. 1 is a block diagram of an environment 100 in which embodiments of the disclosed technology can be implemented. The environment 100 includes a health and fitness engine 115 (hereinafter simply referred to as “fitness engine 115”) that facilitates the users 105 to manage their fitness. The fitness engine 115 can be implemented in various ways. For example, the fitness engine 115 can be implemented as an “app” which can be installed on one or more devices associated with the users 105. The one or more devices can include mobile devices, e.g., a smartphone, a tablet, etc., a personal computer (PC), a desktop, a laptop, etc. The app allows the users 105 to connect to the fitness engine 115 over a communication network 110. The fitness engine 115 can be implemented in a distributed environment having a number of systems. For example, a server portion of the fitness engine 115 can be implemented on a server associated with the fitness engine 115 and a client portion of the fitness engine 115 can be implemented in the app. In some embodiments, the fitness engine 115 can also be implemented as a website that can be accessed via web browsers.

The environment 100 also includes a storage system 120, such as a database, that can store information including player profiles, player Tracks, progress of the player in their Tracks, player rewards, player avatars, etc.

The app supports players 105 wishing to modify their fitness related habits, e.g., eating and exercise habits, by practicing a self-motivational technique. The app will help a player recognize their own “negative self-talk” from which they create their track. The Track is a positive statement designed to override the negative message they identify. The app guides the players 105 on how to establish their own Track and then connects them to others so they can repeat their Track, that is, perform activities towards achieving the goal of the Track, as often as they wish. The player can repeat the track a predefined number of times. In some embodiments, the player is suggested to repeat their Track from at least once a day up to 3 times a day. This repetition helps a player to internalize their positive message and thereby impact the choices they make in the real world.

Players 105 also are incentivized to play as the support player to acknowledge and offer encouragement to those saying their Track. Players 105 earn rewards, including points, stars, virtual gifts, body transformations (also known as “avatars”) and a chance to win a daily sweepstakes by participating. As players achieve milestones in play, their avatar can undergo graphic transformations, e.g., from less to more healthy, and the support players at the same time, accumulate as an aura based on the stars earned for being supportive.

Players 105 can interact with other players to get acknowledged for their Tracks via TrackChat—a chat platform where players connect with friends or other members of groups. In this text exchange, one player declares their “Track” and each player can trigger graphic animations and rewards for the other player based on the quality of that exchange. Players 105 assume one of two roles in these exchanges are rewarded for playing both roles. After completing one exchange, players can easily switch roles with each other to assume the opposite role. Chats can be live or on a delayed messaging basis. Data from these interactions is saved to a storage system 105. Data can be used to calculate rewards, including points, gifts, sweepstake entries and to manage friend and group lists. In some embodiments, the data can also be used to perform various animations, including animations of the avatars and other transformations.

The app can be implemented in various versions. For example, a standard version facilitates players 105 to interact only with other players; a professional version can facilitate players 105 to communicate with a service provider 125 such as fitness and weight management professionals. The service provider 125 can create groups and invite players to become members of a group. The service provider 125 can provide consultation, guide, encourage their clients (e.g., players) to improve their fitness by setting Tracks, monitor and acknowledge their clients' progress in managing their fitness in an effective way. The service provider 125 can communicate with their clients both in the TrackChat and by way of messages, e.g., group and individual messages that appear as device notifications and in a message folder in the app.

### Playing the Game

The player chooses or writes a “Track” (e.g., positive self-statement) that is specific to their personal situation and goals. Each predefined period, e.g., every day, the game presents a predefined number, e.g., 3, negativity clouds over the player's head. The player is connected to another person or with a weight management or fitness professional so that they can “say” their Track by assembling it into a little puzzle. The other player can then remove a cloud and offer encouragement and support via the chat function. Each time a cloud is extinguished, the player is entered into that day's sweepstakes (e.g., up to 3 times each day). A player can also log in as the support player (the person listening to the Track and responding with encouragement), in this role, they have the power to extinguish the other player's cloud. Playing in this support role also enters the player into the sweepstakes up to a maximum of 8 times daily and provides the opportunity to earn stars from the other player for having been supportive. Having clouds cleared and earning stars leads to graphic changes to your avatar so that players transform their avatar from overweight to ideal weight and build an aura until the penultimate graphic status is achieved. Each time a player engages in an interaction, invites friends to join or makes progress, they are also rewarded with points that can be used to purchase virtual products.

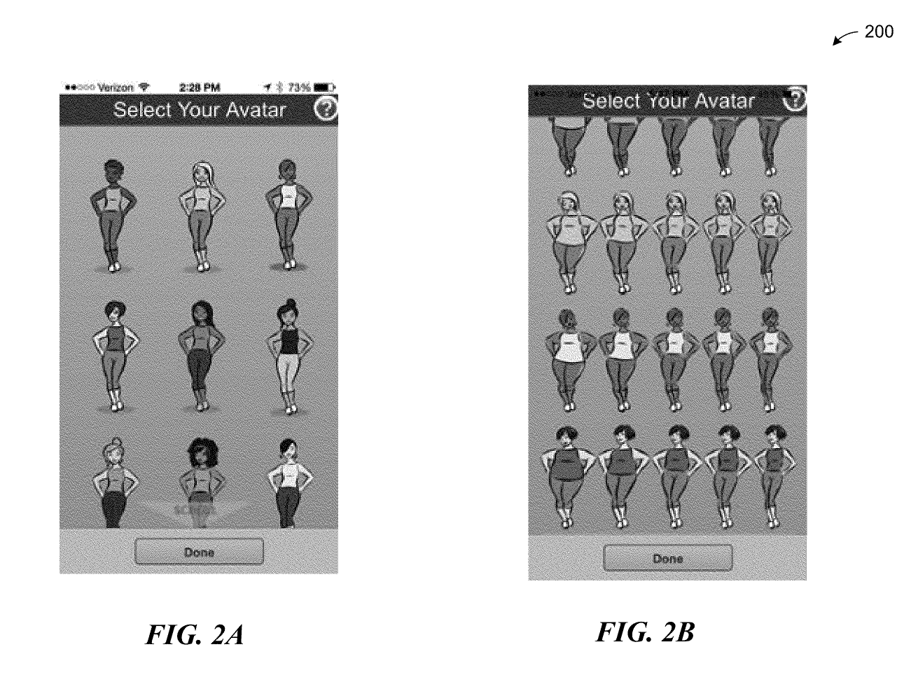

FIGS. 2A and 2B illustrate example user interfaces for selecting an avatar to represent the player, consistent with various embodiments of the disclosed technology. The player may choose a suitable avatar from a predefined list of avatars. The avatars may be designed in such a way that it can depict a particular mood, fitness condition, physical condition, etc. of a human being. The player may choose the one he/she likes. The avatars can also feature various accessories. The avatars can also be animated. Further, in some embodiments, an avatar of a player can be configured to automatically evolve over a period of time to depict the progress of the player on the chosen Track. For example, if a player chooses a Track for losing weight, the avatar can evolve from depicting an overweight person to a normal weight person as the player progresses in the play. FIG. 2B illustrates avatars depicting overweight to normal weight player.

Avatars are used as a simple representation for a player and a player can trigger certain avatar animations. In addition to the user controlled animations, there are certain game controlled animations that are triggered automatically when certain conditions are met in a game play.

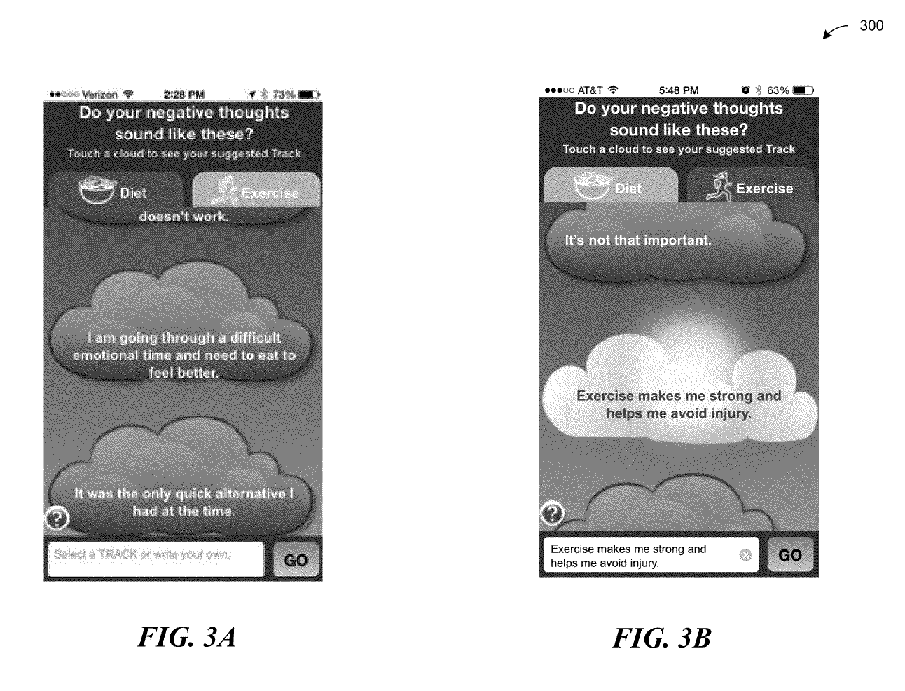

FIGS. 3A and 3B illustrate example user interfaces for creating or selecting a track, consistent with various embodiments of the disclosed technology. The user interface of FIG. 3A presents a player with a number of negative thoughts represented as dark clouds. The player may choose any one of the negative thoughts and convert it into a positive thought as shown in the user interface of FIG. 3B.

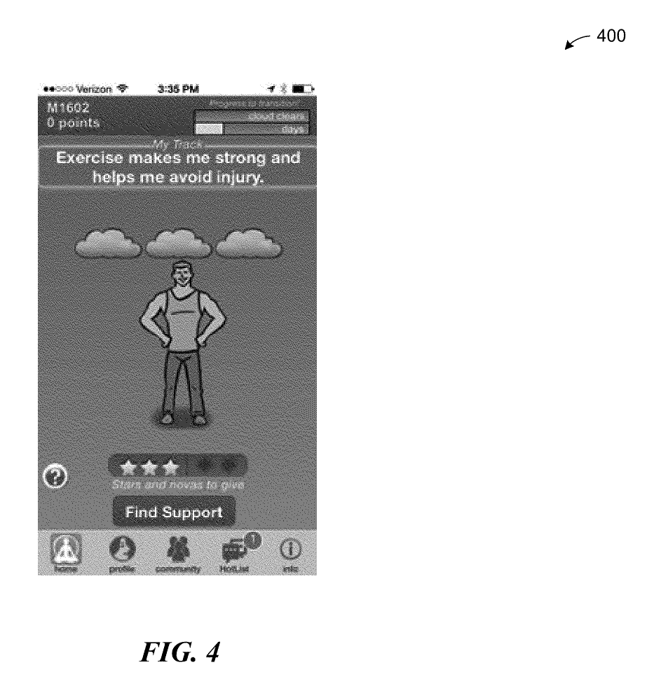

FIG. 4 illustrates a user interface depicting negative clouds for a chosen Track, consistent with various embodiments of the disclosed technology. After the player has chosen a Track, the user interface displays a predefined number of negative clouds, e.g., 3, associated with the player for the particular chosen Track. In order to progress in the play, the player will have to get rid of the negative clouds. In some embodiments, the negative clouds for a player can only be removed by another player.

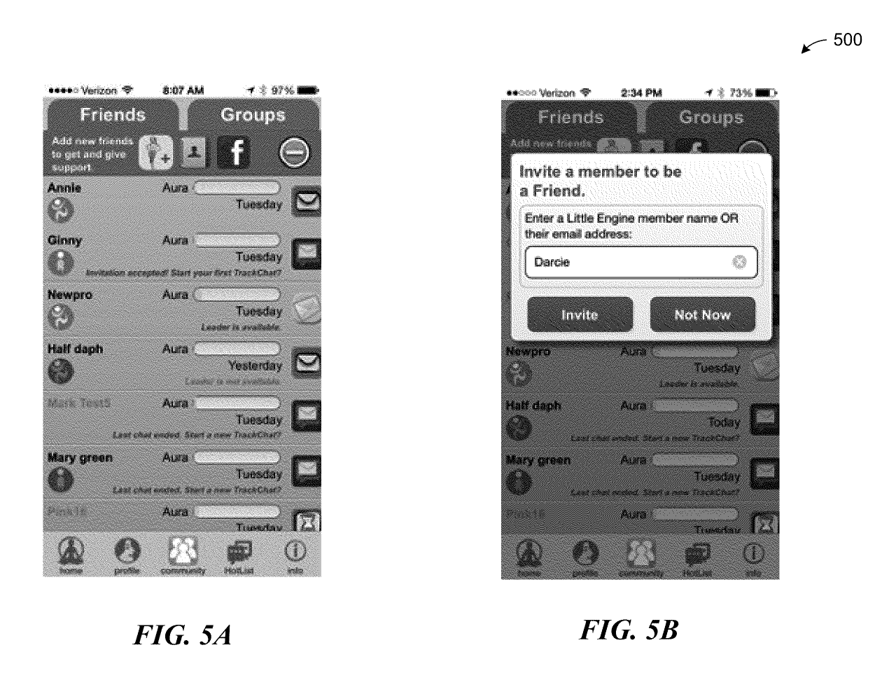

FIGS. 5A and 5B illustrate user interfaces for inviting players to participate in a TrackChat, consistent with various embodiments of the disclosed technology. The player can invite other players in a number of ways, for example, by selecting a player from the “Friends” list as shown in FIG. 5A or by sending a message to the other player using the other player's username as shown in FIG. 5B.

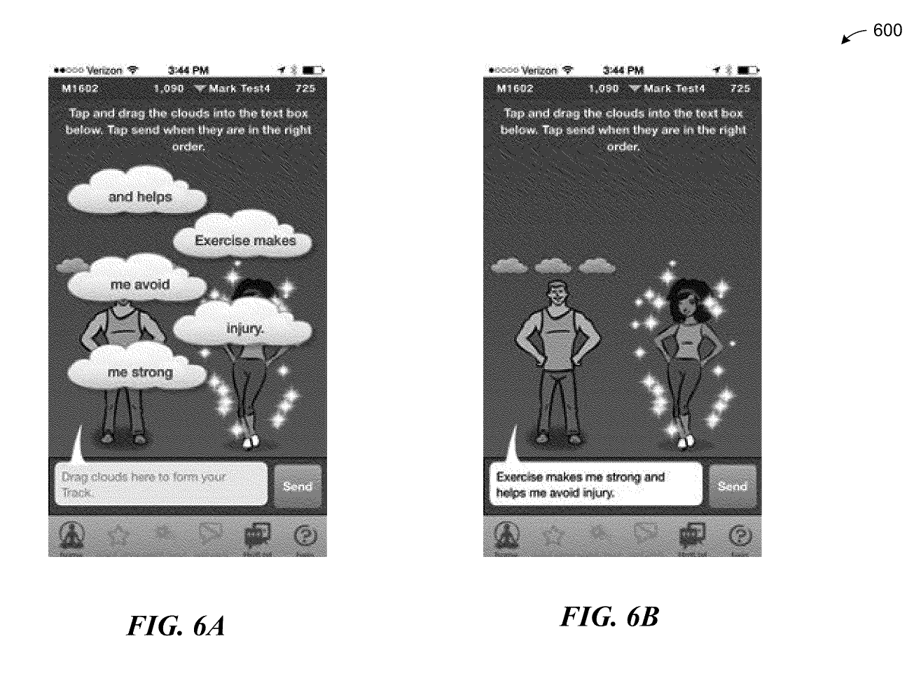

FIGS. 6A and 6B illustrate user interfaces for chatting with players in a TrackChat, consistent with various embodiments of the disclosed technology. After a player has invited another player (e.g., support player) to the TrackChat, the player can send his Track which is a positive trait such as “Exercise makes me strong and helps me avoid injury.” to the support player as shown in FIG. 6B. In some embodiments, the player can “say” their Track by assembling it into a puzzle as shown in FIG. 6A.

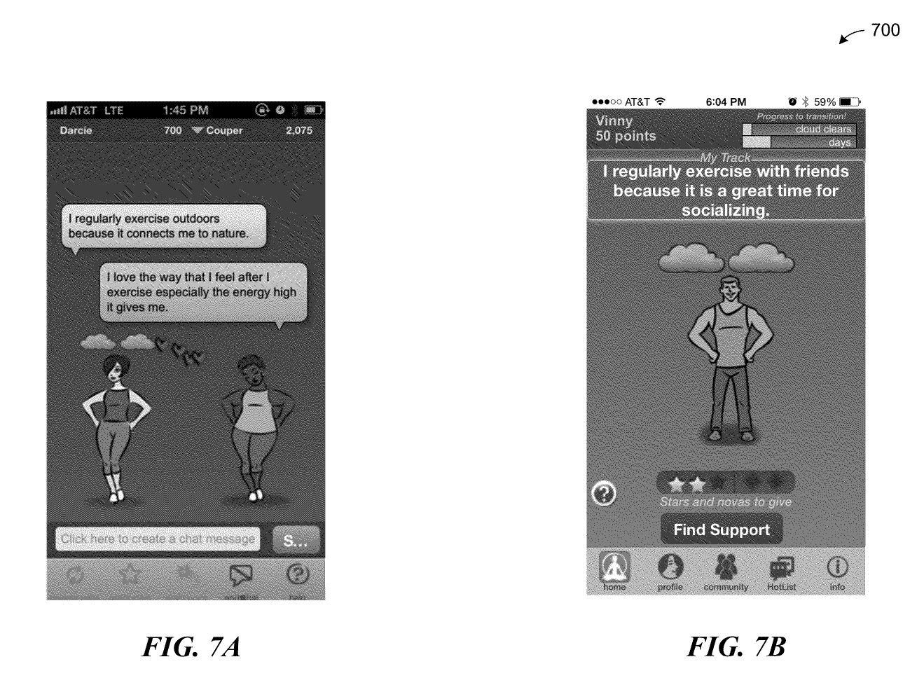

FIGS. 7A and 7B illustrate another set of user interfaces for chatting with players in a TrackChat, consistent with various embodiments of the disclosed technology. After sending the Track, the player and the support player can exchange brief messages as shown in FIG. 7A. For example, the player may message regarding the activities the player performed to follow/implement the Track. The support player can offer encouragement and support and/or remove a cloud via the chat function as shown in FIG. 7B. In some embodiments, the support player may decide whether or not to remove the cloud based on whether the activities performed by the player are focused towards following/implementing Track. The player can then accumulate rewards, for e.g., points for getting rid of the cloud, that is, for implementing his Track as shown by the progress bar in FIG. 7B. The player can also gift rewards, e.g., stars, to the support player. FIG. 6B illustrates stars associated with a support player.

In some embodiments, the player may be required to play this repetitively until the rewards reach a particular threshold. The threshold is configurable and it can be set in such a way that the player repeats the Track until such time that implementing the Track is thought to become a habit of the player thereby resulting in improved fitness. In some embodiments, the number of clouds that can be removed per day and/or the number of clouds that have to be removed before the player can select a next Track is also configurable.

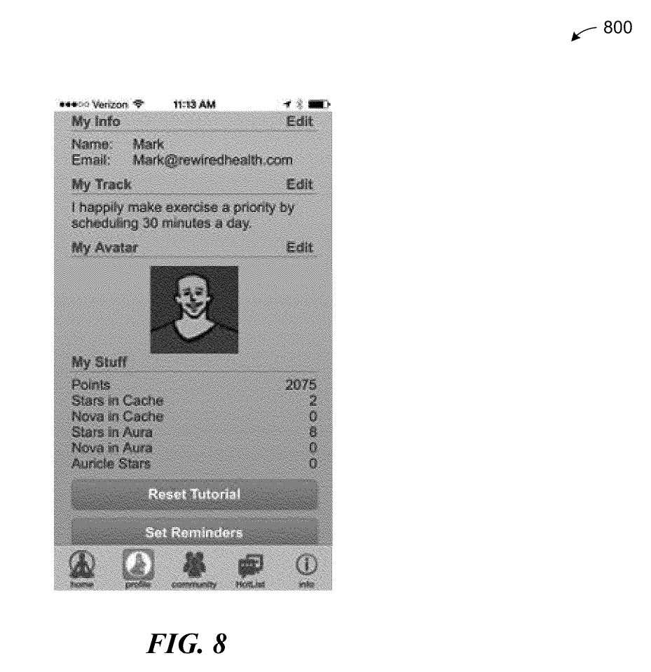

FIG. 8 is an example of a user interface illustrating a profile of a player, consistent with various embodiments of the disclosed technology. The user profile can display various details including, a user name, avatar, points accumulated, stars accumulated, email ID etc.

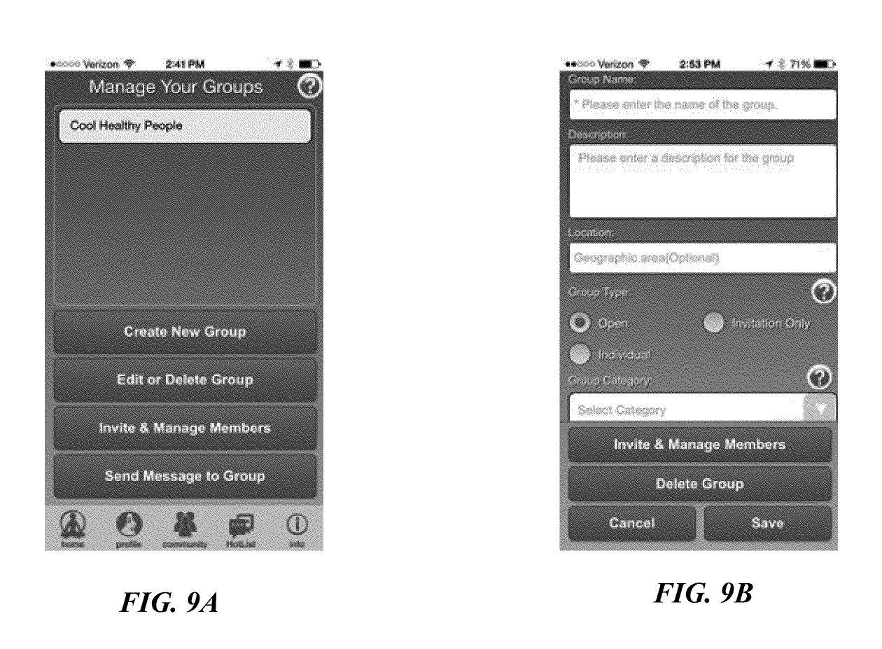

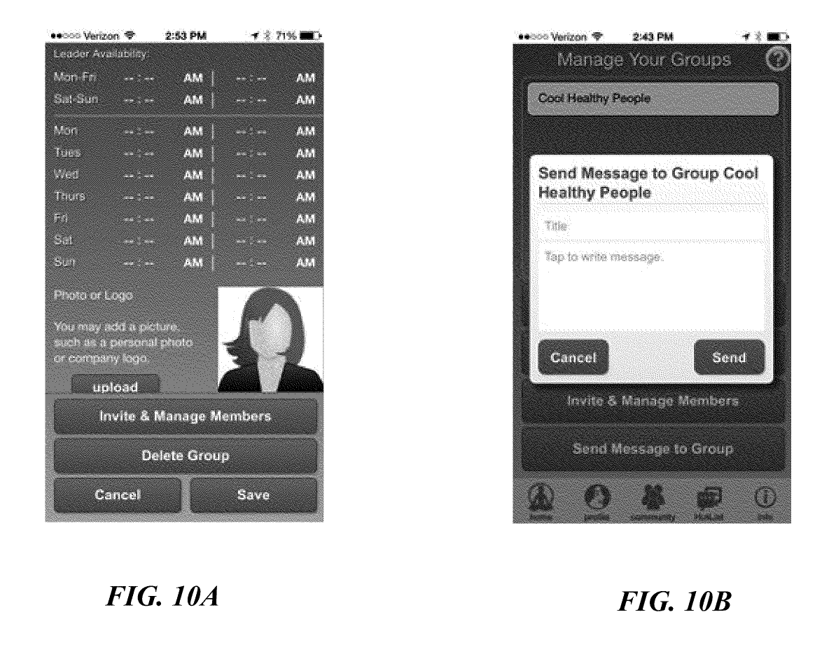

FIGS. 9A, 9B, 10A and 10B are examples illustrating various user interfaces for creating and managing groups by service providers, consistent with various embodiments of the disclosed technology. FIG. 9A is an example of a user interface that can be used by a service provider such as a fitness professional for creating a group of players that the fitness professional is helping. The fitness professional can associate various attributes with the group, including a name, description, whether the group is open type where any player can join the group, or a invite only group where players can only join by invitations, a category of the group etc. as shown in FIG. 9B.

The fitness professional can also set their availabilities to different groups. FIG. 10A is an example user interface for setting fitness professional (“group leader”) availability for a particular group.

The fitness professional can also send messages, including reminders, to the players in the group. FIG. 10B illustrates a user interface for sending messages to the players in the group.

The app can be focused on various health related areas including, but not limited to addiction and alcohol abuse treatment, PTS therapy, eating disorder treatment, diabetes treatment, specialty fitness such as yoga or sports training, etc.

The app also includes various other features. For example, several enhancements to various animations. Using the enhanced animations, users will be able to choose other graphics for clearing clouds and thanking others for their support can in addition to sending hearts, stars and lightning bolts. The graphics can be graphic depictions from the categories, including Kindness (hearts), Empowerment, Serenity and Support.

Events can happen to avatars to indicate their progress or lack of progress. For example,
Sun can appear after multiple cloud clears.
Uncleared clouds can rain on the avatar, causing water to rise around the avatar.
Time-based variations will be used to provide interest: Sun may be replaced by a smiling moon in the evening, etc.
Seasonal variations will be used to provide interest: rainbows in spring/summer, falling leaves in autumn, snow in winter, etc.
Avatars may be placed in environments (yoga studio, gym, etc.) where situationally appropriate events can happen to encourage or reward them.

The app can include a suite of choices to depict emotional reaction. Some examples include:
Namaste (thanks)
fist pump
Raise the roof dance
Stage bow
Belly laugh
Awe shucks
and numerous others

These will be accessed via a visual library of animated expressions accessed by touching the avatar.

### Avatar Body Expressions

Users can choose from a set of avatar “looks” depending on how they feel that day. These avatar expressions may also occur automatically to indicate how successfully the user has progressed in the game.
Overweight and out of shape
Fit and energetic
Tired and overwhelmed
Tense and anxious
Calm and self assured

### Avatar Behavior Animations

Additional avatar animations to reinforce healthy behavior can be tied to success in game play—research shows that people are more likely to behave in a healthy way after witnessing an avatar that they relate to personally engaging in that behavior.

### EXAMPLES

Eats a salad
Snacks on raw veggies and fruits
Goes for a run
Goes for a bike ride
Does exercises
Does yoga poses/routines
Goes for a walk

### Gifting

Avatars can send gifts of virtual products to their avatar or to each others' avatars to reinforce healthy choices.
Gift basket of herbal and green teas
A teapot and tea cups
Packets of seeds that are herbs or vegetables
Yoga mat
Weights
Workout ball
Fruit bowl
Fresh veggies
Herbal garden

Avatars can use these gifts—drink a tea, exercise with weights, etc.—in animated actions.

### Affirmation Selection and Reminder

Users can be presented with clouds that represent problems that they may be experiencing, based on negative thoughts that they have. They can be grouped according to areas like Diet and Exercise. The user taps on the cloud to view a positive alternative (an “affirmation,” or a “Track”) which they may select. The user may personalize this affirmation by editing it.

This Track statement then becomes a daily reminder that helps them change their thinking and improve their behavior. It can be incorporated into the avatar chat process via a game that enables them to assemble the words of their Track, thus reminding them of their commitment.

### Bulletin Board

Groups can have a board that is visible to all members and can be posted to by all members. Postings can include:
Photos
Videos
Articles
Links to blogs,
Links to purchase books, music, other merchandise, etc.

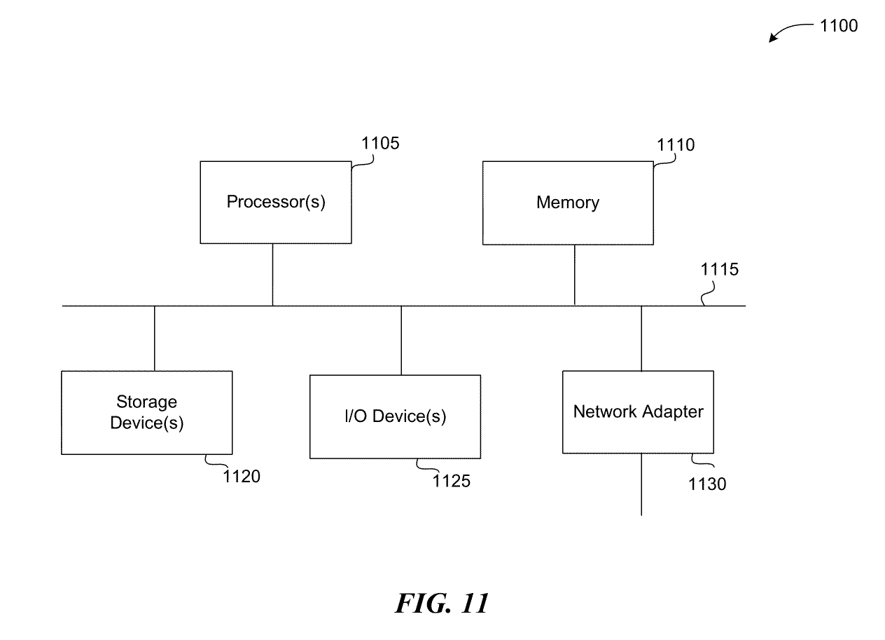

FIG. 11 is a block diagram of a computer system as may be used to implement features of some embodiments of the disclosed technology. The computing system 1100 may be used to implement any of the entities, components or services depicted in the examples of FIGS. 1-10 (and any other components described in this specification). The computing system 1100 may include one or more central processing units (“processors”) 1105, memory 1110, input/output devices 1125 (e.g., keyboard and pointing devices, display devices), storage devices 1120 (e.g., disk drives), and network adapters 1130 (e.g., network interfaces) that are connected to an interconnect 1115. The interconnect 1115 is illustrated as an abstraction that represents any one or more separate physical buses, point to point connections, or both connected by appropriate bridges, adapters, or controllers. The interconnect 1115, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 1110 and storage devices 1120 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 1110 can be implemented as software and/or firmware to program the processor(s) 1105 to carry out actions described above. In some embodiments, such software or firmware may be initially provided to the processing system 1100 by downloading it from a remote system through the computing system 1100 (e.g., via network adapter 1130).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments. For example, the negative clouds may be depicted in various other ways, for example, as a progress bar, as a percentage value, a certain number according to a scale, other graphical images etc. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/we claim:

1. A computer-implemented method comprising:
generating a first set of messages, wherein each of the first set of messages indicates a negative thought of a user;
receiving a user selection of a first message from the first set of messages;
generating a track corresponding to the first message, the track indicating a positive trait of the user, the track associated with a first set of images representing the negative thought;
exchanging, between the user and a first user, one or more messages that indicate actions performed by the user to implement the track;
receiving, by the user and from the first user, input to delete an image from the first set of images responsive to a determination by the first user that the actions performed by the user are directed to implementing the track; and
deleting the image from the first set of images, wherein the track is considered to be implemented by the user if all images from the first set of images are deleted.
